(19) United States
(12) Patent Application Publication
(10) Pub. No.: US 2015/0091841 A1
(43) Pub. Date: Apr. 2, 2015

(54) MULTI-PART GESTURE FOR OPERATING AN ELECTRONIC PERSONAL DISPLAY

(71) Applicant: Kobo Incorporated, Toronto (CA)

(72) Inventors: Damian Lewis, Toronto (CA); Ryan Sood, Toronto (CA)

(21) Appl. No.: 14/042,116

(22) Filed: Sep. 30, 2013

(51) Int. Cl. G06F 3/044; G06F 3/0488

(52) U.S. Cl. CPC G06F 3/044; G06F 3/0488
USPC 345/174

(57) ABSTRACT

A method and system for utilizing a multi-part gesture for operating an electronic personal display is disclosed. One example couples at least one gesture recognitions sensor with the electronic personal display. A multi-part gesture is recognized at the at least one gesture recognition sensor. The multi-part gesture includes a first gesture part invoking a pre-defined set of digital reading operations to be performed on a digital content item rendered on the electronic personal display and at least a second gesture part invoking a specific digital reading operation from the pre-defined set of digital reading operations. Once determined, the specific digital reading operation is performed on the electronic personal display.

### BACKGROUND

An electronic reader, also known as an eReader, is a mobile electronic device that is used for reading electronic books (eBooks), electronic magazines, and other digital content. For example, the content of an eBook is displayed as words and/or images on the display of an eReader such that a user may read the content much in the same way as reading the content of a page in a paper-based book. An eReader provides a convenient format to store, transport, and view a large collection of digital content that would otherwise potentially take up a large volume of space in traditional paper format.

In some instances, eReaders are purpose built devices designed especially to perform especially well at displaying readable content. For example, a purpose built eReader may include a display that reduces glare, performs well in high light conditions, and/or mimics the look of text on actual paper. While such purpose built eReaders may excel at displaying content for a user to read, they may also perform other functions, such as displaying images, emitting audio, recording audio, and web surfing, among others.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description of the drawings should not be understood as being drawn to scale unless specifically noted.

FIG. 1A shows a front perspective view of an electronic reader (eReader), in accordance with various embodiments.

FIG. 1B shows a rear perspective view of the eReader of FIG. 1A, in accordance with various embodiments.

FIG. 2A shows a cross-section of the eReader of FIG. 1A along with a detail view of a portion of the display of the eReader, in accordance with various embodiments.

FIG. 2B shows a side perspective view of a 3D motion sensor, in accordance with various embodiments.

FIG. 3 shows a cutaway view of an eReader illustrating one example of a touch sensor, in accordance with an embodiment.

FIG. 4 shows an example computing system which may be included as a component of an eReader, according to various embodiments.

FIG. 5 shows a block diagram of a multi-part gesture recognition system for an electronic personal display, according to various embodiments.

FIG. 6 illustrates a flow diagram of a method for utilizing multi-part gesture recognition for operating an electronic personal display, according to various embodiments.

FIG. 7A shows a side view of a tap contact recognized portion of a multi-part gesture for operating an electronic personal display, according to various embodiments.

FIG. 7B shows a top view of a swiping contact recognized portion of a multi-part gesture for operating an electronic personal display, according to various embodiments.

FIG. 8A shows a side view of a tap contact recognized portion of a multi-part gesture for operating an electronic personal display, according to various embodiments.

FIG. 8B shows a profile view of a 3-D motion recognized portion of a multi-part gesture for operating an electronic personal display, according to various embodiments.

FIG. 9A shows a perspective view of an accelerometer recognized portion of a multi-part gesture for operating an electronic personal display, according to various embodiments.

FIG. 9B shows a top view of a swiping contact recognized portion of a multi-part gesture for operating an electronic personal display, according to various embodiments.

FIG. 10A shows a perspective view of an accelerometer recognized portion of a multi-part gesture for operating an electronic personal display, according to various embodiments.

FIG. 10B shows a profile view of a 3-D motion recognition portion of a multi-part gesture for operating an electronic personal display, according to various embodiments.

### DESCRIPTION OF EMBODIMENTS

Reference will now be made in detail to embodiments of the subject matter, examples of which are illustrated in the accompanying drawings. While the subject matter discussed herein will be described in conjunction with various embodiments, it will be understood that they are not intended to limit the subject matter to these embodiments. On the contrary, the presented embodiments are intended to cover alternatives, modifications and equivalents, which may be included within the spirit and scope of the various embodiments as defined by the appended claims. Furthermore, in the Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

### Notation and Nomenclature

Unless specifically stated otherwise as apparent from the following discussions, it is appreciated that throughout the present Description of Embodiments, discussions utilizing terms such as “coupling”, “monitoring”, “detecting”, “generating”, “outputting”, “receiving”, “monitoring”, powering-up“, “powering down” or the like, often refer to the actions and processes of an electronic computing device/system, such as an electronic reader (“eReader”), electronic personal display, and/or a mobile (i.e., handheld) multimedia device, among others. The electronic computing device/system manipulates and transforms data represented as physical (electronic) quantities within the circuits, electronic registers, memories, logic, and/or components and the like of the electronic computing device/system into other data similarly represented as physical quantities within the electronic computing device/system or other electronic computing devices/systems.

### Overview of Discussion

In the following discussion multi-part gesture operation of an electronic personal display is disclosed. In one embodiment, the electronic personal display includes one or more sensors from the group of sensors including: a touch sensor, a 3-D motion sensor and an accelerometer. One embodiment describes multi-part gestures that are performed to cause an electronic personal device to perform an action. For example, the multi-part gesture consists of a first gesture part and at least a second gesture part. In general, the first gesture part invokes a reduced set of operations that can be performed while the second gesture part invokes a specific operation from the reduced set.

However, the multi-part gesture does not need to be performed with a pause between parts of the gesture. For example, assume the multi part gesture for adjusting the brightness of the screen is a touch of the top right portion of the screen followed by a clockwise hand motion. The user can perform the touching of the screen and then the clockwise hand motion without pausing between the gestures or waiting for feedback from the device. The multi-part gesture recognition system will parse the gestures and then perform the requested operation. In other words, the user will know that the touching of the top right portion of the screen accesses the display controls command menu and that the clockwise hand motion is the gesture that correlates with the display brightness adjustment. Thus, in one embodiment, there is no presentation of the display controls command menu to the user.

Although the multi-part gesture is described as having two parts, the number of parts may be greater than two. For example if a gesture included three parts, each part would narrow the number of digital reading operations included in the set until the last gesture selected a specific operation to be performed

Discussion will begin with description of an example eReader and various components that may be included in some embodiments of an eReader. Various display and touch sensing technologies that may be utilized with some embodiments of an eReader will then be described. An example computing system, which may be included as a component of an eReader, will then be described. Operation of an example eReader and several of its components will then be described in more detail in conjunction with a description of an example method of utilizing a non-screen capacitive touch surface for operating an electronic personal display.

### Example Electronic Reader (eReader)

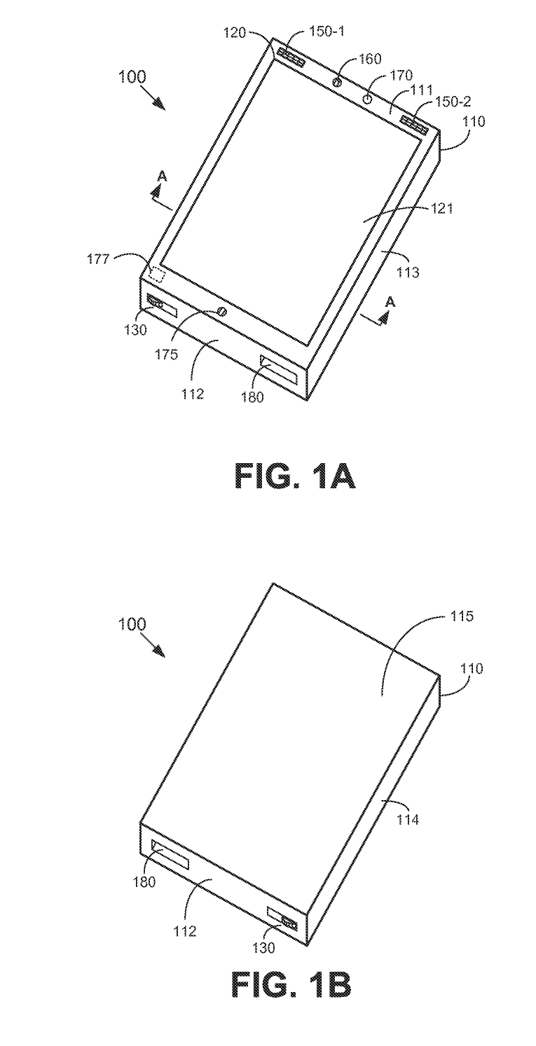

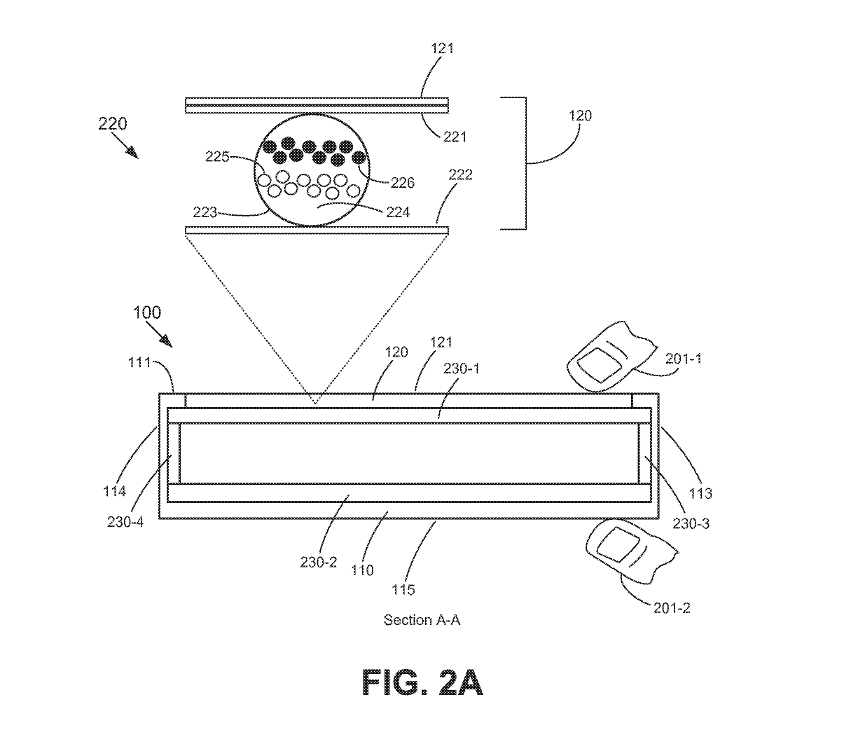

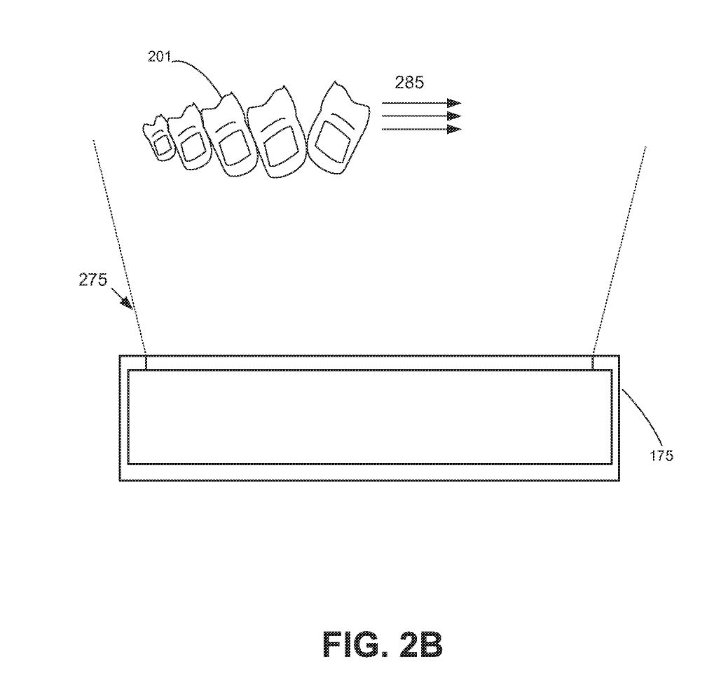

FIG. 1A shows a front perspective view of an eReader 100, in accordance with various embodiments. In general, eReader 100 is one example of an electronic personal display. Although an eReader is discussed specifically herein for purposes of example, concepts discussed are equally applicable to other types of electronic personal displays such as, but not limited to, mobile digital devices/tablet computers and/or multimedia smart phones. As depicted, eReader 100 includes a display 120, a housing 110, and some form of on/off switch 130. In some embodiments, eReader 100 may further include one or more of: speakers 150 (150-1 and 150-2 depicted), microphone 160, digital camera 170, 3D motion sensor 175, accelerometer 177 and removable storage media slot 180. Section lines depict a region and direction of a section A-A which is shown in greater detail in FIG. 2A.

Housing 110 forms an external shell in which display 120 is situated and which houses electronics and other components that are included in an embodiment of eReader 100. In FIG. 1A, a front surface 111, a bottom surface 112, and a right side surface 113 are visible. Although depicted as a single piece, housing 110 may be formed of a plurality of joined or inter-coupled portions. Housing 110 may be formed of a variety materials such as plastics, metals, or combinations of different materials.

Display 120 has an outer surface 121 (sometimes referred to as a bezel) through which a user may view digital contents such as alphanumeric characters and/or graphic images that are displayed on display 120. Display 120 may be any one of a number of types of displays including, but not limited to: a liquid crystal display, a light emitting diode display, a plasma display, a bistable display or other display suitable for creating graphic images and alphanumeric characters recognizable to a user.

On/off switch 130 is utilized to power on/power off eReader 100. On/off switch 130 may be a slide switch (as depicted), button switch, toggle switch, touch sensitive switch, or other switch suitable for receiving user input to power on/power off eReader 100.

Speaker(s) 150, when included, operates to emit audible sounds from eReader 100. A speaker 150 may reproduce sounds from a digital file stored on or being processed by eReader 100 and/or may emit other sounds as directed by a processor of eReader 100.

Microphone 160, when included, operates to receive audible sounds from the environment proximate eReader 100. Some examples of sounds that may be received by microphone 160 include voice, music, and/or ambient noise in the area proximate eReader 100. Sounds received by microphone 160 may be recorded to a digital memory of eReader 100 and/or processed by a processor of eReader 100.

Digital camera 170, when included, operates to receive images from the environment proximate eReader 100. Some examples of images that may be received by digital camera 170 include an image of the face of a user operating eReader 100 and/or an image of the environment in the field of view of digital camera 170. Images received by digital camera 170 may be still or moving and may be recorded to a digital memory of eReader 100 and/or processed by a processor of eReader 100.

3D motion sensor 175, when included, monitors for motion within a portion of airspace in the environment proximate eReader 100. Some examples of motion that may be detected include sideways motions, up and down motions, depth motions and a combination of the afore mentioned motions. Granularity with respect to the level of motion detected by 3D motion sensor 175 may be preset or user adjustable. Motions detected by 3D motion sensor 175 may be recorded to a digital memory of eReader 100 and/or processed by a processor of eReader 100. In one embodiment, 3D motion sensor 175 is fixedly coupled with housing 110 of eReader 100. However, in another embodiment, 3D motion sensor 175 may be removably coupled with eReader 100 such as a wired or wireless connection.

Accelerometer 177, when included, monitors for movement of eReader 100. Some examples of movement that may be detected include sideways movements, up and down movements, back and forth movements and a combination of the movements. Granularity with respect to the level of movement detected by accelerometer 177 may be preset or user adjustable. Movements detected by accelerometer 177 may be recorded to a digital memory of eReader 100 and/or processed by a processor of eReader 100. In one embodiment, accelerometer 177 is fixedly coupled within the housing 110 of eReader 100. However, in another embodiment, accelerometer 177 may be removably coupled with eReader 100 such as a wired or wireless connection.

Removable storage media slot 180, when included, operates to removably couple with and interface to an inserted item of removable storage media, such as a non-volatile memory card (e.g., MultiMediaCard (“MMC”), a secure digital (“SD”) card, or the like). Digital content for play by eReader 100 and/or instructions for eReader 100 may be stored on removable storage media inserted into removable storage media slot 180. Additionally or alternatively, eReader 100 may record or store information on removable storage media inserted into removable storage media slot 180.

FIG. 1B shows a rear perspective view of eReader 100 of FIG. 1A, in accordance with various embodiments. In FIG. 1B, a rear surface 115 of the non-display side of the housing 110 of eReader 100 is visible. Also visible in FIG. 1B is a left side surface 114 of housing 110. It is appreciated that housing 110 also includes a top surface which is not visible in either FIG. 1A or FIG. 1B.

FIG. 2A shows a cross-section A-A of eReader 100 along with a detail view 220 of a portion of display 120, in accordance with various embodiments. In addition to display 120 and housing 110, a plurality of touch sensors 230 are visible and illustrated in block diagram form. It should be appreciated that a variety of well-known touch sensing technologies may be utilized to form touch sensors 230 that are included in embodiments of eReader 100; these include, but are not limited to: resistive touch sensors; capacitive touch sensors (using self and/or mutual capacitance); inductive touch sensors; and infrared touch sensors. In general, resistive touch sensing responds to pressure applied to a touched surface and is implemented using a patterned sensor design on, within, or beneath display 120, rear surface 115, and/or other surface of housing 110. In general, inductive touch sensing requires the use of a stylus and are implemented with a patterned electrode array disposed on, within, or beneath display 120, rear surface 115, and/or other surface of housing 110 In general, capacitive touch sensing utilizes a patterned electrode array disposed on, within, or beneath display 120, rear surface 115, and/or other surface of housing 110; and the patterned electrodes sense changes in capacitance caused by the proximity or contact by an input object. In general, infrared touch sensing operates to sense an input object breaking one or more infrared beams that are projected over a surface such as outer surface 121, rear surface 115, and/or other surface of housing 110.

Once an input object interaction is detected by a touch sensor 230, it is interpreted either by a special purpose processor (e.g., an application specific integrated circuit (ASIC)) that is coupled with the touch sensor 230 and the interpretation is passed to a processor of eReader 100, or a processor of eReader is used to directly operate and/or interpret input object interactions received from a touch sensor 230. It should be appreciated that in some embodiments, patterned sensors and/or electrodes may be formed of optically transparent material such as very thin wires or a material such as indium tin oxide (ITO).

In various embodiments one or more touch sensors 230 (230-1 front; 230-2 rear; 230-3 right side; and/or 230-4 left side) may be included in eReader 100 in order to receive user input from input object 201 such as styli or human digits. For example, in response to proximity or touch contact with outer surface 121 or coversheet (not illustrated) disposed above outer surface 121, user input from one or more fingers such as finger 201-1 may be detected by touch sensor 230-1 and interpreted. Such user input may be used to interact with graphical content displayed on display 120 and/or to provide other input through various gestures (e.g., tapping, swiping, pinching digits together on outer surface 121, spreading digits apart on outer surface 121, or other gestures).

In a similar manner, in some embodiments, a touch sensor 230-2 may be disposed proximate rear surface 115 of housing 110 in order to receive user input from one or more input objects 201, such as human digit 201-2. In this manner, user input may be received across all or a portion of the rear surface 115 in response to proximity or touch contact with rear surface 115 by one or more user input objects 201. In some embodiments, where both front (230-1) and rear (230-2) touch sensors are included, a user input may be received and interpreted from a combination of input object interactions with both the front and rear touch sensors.

In a similar manner, in some embodiments, a left side touch sensor 230-3 and/or a right side touch sensor 230-4, when included, may be disposed proximate the respective left and/or right side surfaces (113, 114) of housing 110 in order to receive user input from one or more input objects 201. In this manner, user input may be received across all or a portion of the left side surface 113 and/or all or a portion of the right side surface 114 of housing 110 in response to proximity or touch contact with the respective surfaces by or more user input objects 201. In some embodiments, instead of utilizing a separate touch sensor, a left side touch sensor 230-3 and/or a right side touch sensor 230-4 may be a continuation of a front touch sensor 230-1 or a rear touch sensor 230-2 which is extended so as to facilitate receipt proximity/touch user input from one or more sides of housing 110.

Although not depicted, in some embodiments, one or more touch sensors 230 may be similarly included and situated in order to facilitate receipt of user input from proximity or touch contact by one or more user input objects 201 with one or more portions of the bottom 112 and/or top surfaces of housing 110.

Referring still to FIG. 2A, a detail view 220 is show of display 120, according to some embodiments. Detail 220 depicts a portion of a bistable electronic ink that is used, in some embodiments, when display 120 is a bistable display. In some embodiments, a bistable display is utilized in eReader 100 as it presents a paper and ink like image and/or because it is a reflective display rather than an emissive display and thus can present a persistent image on display 120 even when power is not supplied to display 120. In one embodiment, a bistable display comprises electronic ink the form of millions of tiny optically clear capsules 223 that are filled with an optically clear fluid 224 in which positively charged white pigment particles 225 and negatively charged black pigment particles 226 are suspended. The capsules 223 are disposed between bottom electrode 222 and a transparent top electrode 221. A transparent/optically clear protective surface is often disposed over the top of top electrode 221 and, when included, this additional transparent surface forms outer surface 121 of display 120 and forms a touch surface for receiving touch inputs. It should be appreciated that one or more intervening transparent/optically clear layers may be disposed between top electrode 221 and top electrode 221. In some embodiments, one or more of these intervening layers may include a patterned sensor and/or electrodes for touch sensor 230-1. When a positive or negative electric field is applied proximate to each of bottom electrode 222 and top electrode 221 in regions proximate capsule 223, pigment particles of opposite polarity to a field are attracted to the field, while pigment particles of similar polarity to the applied field are repelled from the field. Thus, when a positive charge is applied to top electrode 221 and a negative charge is applied to bottom electrode 221, black pigment particles 226 rise to the top of capsule 223 and white pigment particles 225 go to the bottom of capsule 223. This makes outer surface 121 appear black at the point above capsule 223 on outer surface 121. Conversely, when a negative charge is applied to top electrode 221 and a positive charge is applied to bottom electrode 221, white pigment particles 225 rise to the top of capsule 223 and black pigment particles 226 go to the bottom of capsule 223. This makes outer surface 121 appear white at the point above capsule 223 on outer surface 121. It should be appreciated that variations of this technique can be employed with more than two colors of pigment particles.

FIG. 2B shows a 3D motion sensor 175 with a range 275 within which motion may be sensed to receive user input. In various embodiments one or more 3D motion sensor 175 may be included in eReader 100 in order to receive user input from input object 201 such as styli or human digits. For example, in response to a motion 285 within the airspace 275, user input from one or more fingers such as fingers 201 may be detected by 3D motion sensor 175 and interpreted. Such user input may be used to interact with graphical content displayed on display 120 and/or to provide other input through various gestures. In general, 3D motion sensor 175 may recognize motions performed in one or more of the x-, y- and z-axis. For example, a side-to-side motion would be differentiated from an up and down motion. Moreover, depending on the desired granularity of the 3D motion sensor 175 additional differentiations may be made between a horizontal side-to-side motion and a sloping side-to-side motion. In one embodiment, the 3D motion sensor 175 may be incorporated with digital camera 170 into a single device.

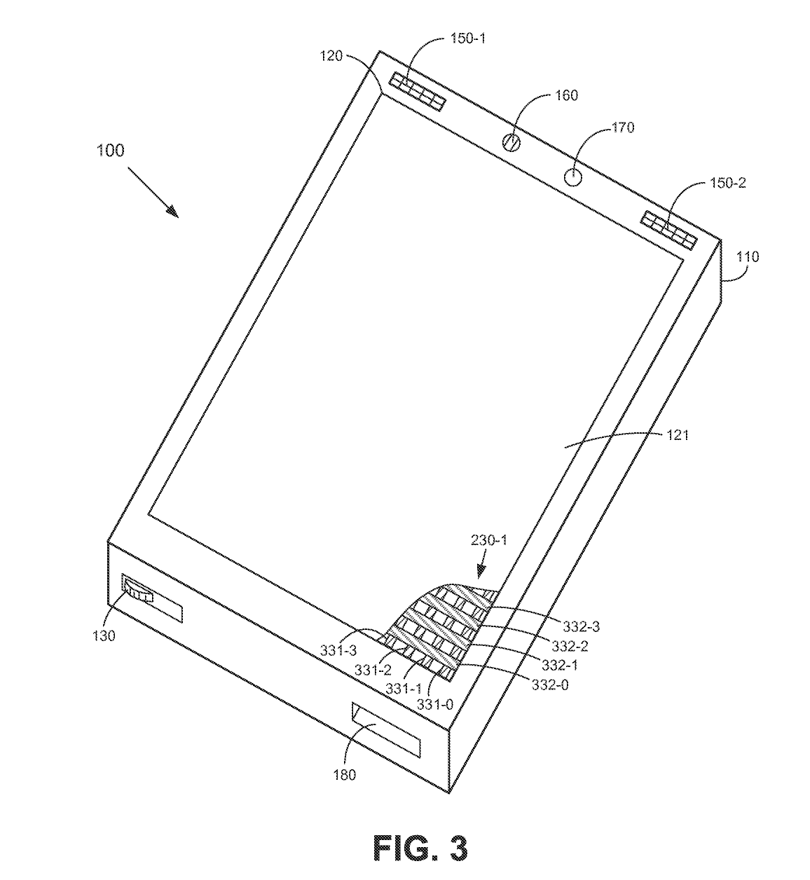

FIG. 3 shows a cutaway view of an eReader illustrating one example of a touch sensor 230, in accordance with an embodiment. In FIG. 3, a portion of display 120 has been removed such that a portion of underlying top sensor 230-1 is visible. As depicted, in one embodiment, top touch sensor 230-1 is illustrated as an x-y grid of sensor electrodes which may be used to perform various techniques of capacitive sensing. For example, sensor electrodes 331 (331-0, 331-1, 331-2, and 331-3 visible) are arrayed along a first axis, while sensor electrodes 332 (332-0, 332-1, 332-2, and 332-3 visible) are arrayed along a second axis that is approximately perpendicular to the first axis. It should be appreciated that a dielectric layer (not illustrated) is disposed between all or portions of sensor electrodes 331 and 332 to prevent shorting. It should also be appreciated that the pattern of sensor electrodes (331, 332) illustrated in FIG. 3 has been provided an example only, that a variety of other patterns may be similarly utilized, and some of these patterns may only utilize sensor electrodes disposed in a single layer. Additionally, while the example of FIG. 3 illustrates top sensor 230-1 as being disposed beneath display 120, in other embodiments, portions of touch sensor 230-1 may be transparent and disposed either above display 120 or integrated with display 120.

In one embodiment, by performing absolute/self-capacitive sensing with sensor electrodes 331 on the first axis a first profile of any input object contacting outer surface 121 can be formed, and then a second profile of any input object contacting outer surface 121 can be formed on an orthogonal axis by performing absolute/self-capacitive sensing on sensor electrodes 332. These capacitive profiles can be processed to determine an occurrence and/or location of a user input with made by means of an input object 201 contacting or proximate outer surface 121.

In another embodiment, by performing transcapacitive/mutual capacitive sensing between sensor electrodes 331 on the first axis and sensor electrodes 332 on the second axis a capacitive image can be formed of any input object contacting outer surface 121. This capacitive image can be processed to determine occurrence and/or location of user input made by means of an input object contacting or proximate outer surface 121.

It should be appreciated that mutual capacitive sensing is regarded as a better technique for detecting multiple simultaneous input objects in contact with a surface such as outer surface 121, while absolute capacitive sensing is regarded as a better technique for proximity sensing of objects which are near but not necessarily in contact with a surface such as outer surface 121.

In some embodiments, capacitive sensing and/or another touch sensing technique may be used to sense touch input across all or a portion of the rear surface 115 of eReader 100, and/or any other surface(s) of housing 110.

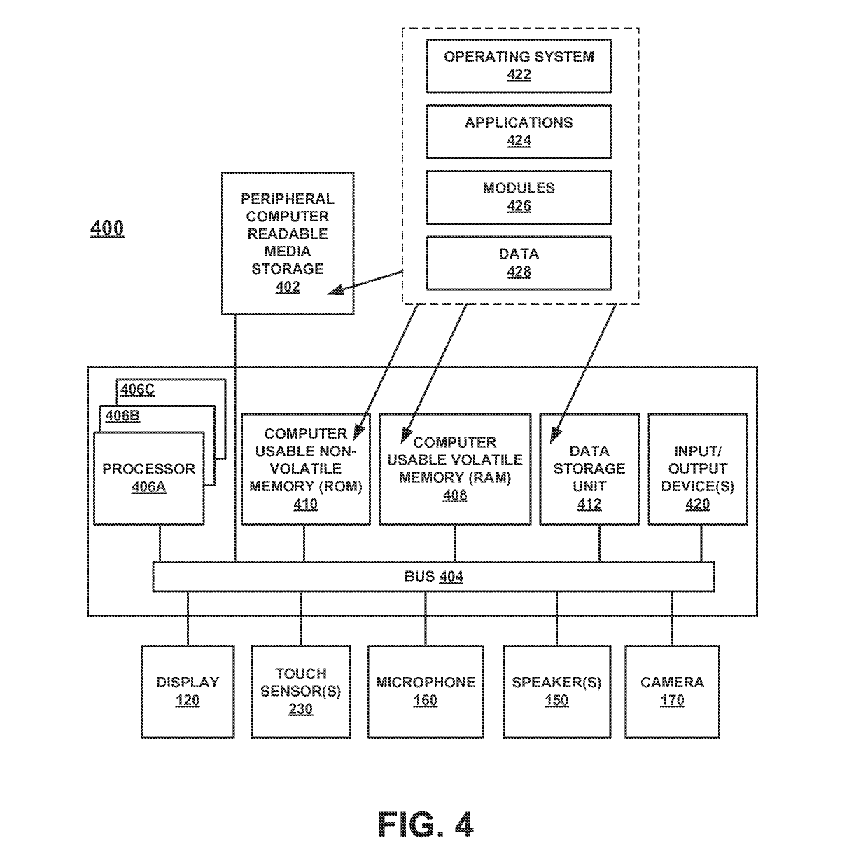

FIG. 4 shows an example computing system 400 which may be included as a component of an eReader, according to various embodiments and with which or upon which various embodiments described herein may operate.

### Example Computer System Environment

With reference now to FIG. 4, all or portions of some embodiments described herein are composed of computer-readable and computer-executable instructions that reside, for example, in computer-usable/computer-readable storage media of a computer system. That is, FIG. 4 illustrates one example of a type of computer (computer system 400) that can be used in accordance with or to implement various embodiments of an eReader, such as eReader 100, which are discussed herein. It is appreciated that computer system 400 of FIG. 4 is only an example and that embodiments as described herein can operate on or within a number of different computer systems.

System 400 of FIG. 4 includes an address/data bus 404 for communicating information, and a processor 406A coupled to bus 404 for processing information and instructions. As depicted in FIG. 4, system 400 is also well suited to a multi-processor environment in which a plurality of processors 406A, 406B, and 406C are present. Processors 406A, 406B, and 406C may be any of various types of microprocessors. For example, in some multi-processor embodiments, one of the multiple processors may be a touch sensing processor and/or one of the processors may be a display processor. Conversely, system 400 is also well suited to having a single processor such as, for example, processor 406A. System 400 also includes data storage features such as a computer usable volatile memory 408, e.g., random access memory (RAM), coupled to bus 404 for storing information and instructions for processors 406A, 406B, and 406C. System 400 also includes computer usable non-volatile memory 410, e.g., read only memory (ROM), coupled to bus 404 for storing static information and instructions for processors 406A, 406B, and 406C. Also present in system 400 is a data storage unit 412 (e.g., a magnetic or optical disk and disk drive) coupled to bus 404 for storing information and instructions.

Computer system 400 of FIG. 4 is well adapted to having peripheral computer-readable storage media 402 such as, for example, a floppy disk, a compact disc, digital versatile disc, universal serial bus “flash” drive, removable memory card, and the like coupled thereto. In some embodiments, computer-readable storage media 402 may be coupled with computer system 400 (e.g., to bus 404) by insertion into removable a storage media slot, such as removable storage media slot 180 depicted in FIGS. 1A and 1B.

System 400 also includes or couples with display 120 for visibly displaying information such as alphanumeric text and graphic images. In some embodiments, system 400 also includes or couples with one or more optional sensors 430 for communicating information, cursor control, gesture input, command selection, and/or other user input to processor 406A or one or more of the processors in a multi-processor embodiment. In general, optional sensors 420 may include, but is not limited to, touch sensor 230, 3D motion sensor 175, accelerometer 177 and the like. In some embodiments, system 400 also includes or couples with one or more optional speakers 150 for emitting audio output. In some embodiments, system 400 also includes or couples with an optional microphone 160 for receiving/capturing audio inputs. In some embodiments, system 400 also includes or couples with an optional digital camera 170 for receiving/capturing digital images as an input.

Optional sensor(s) 430 allows a user of computer system 400 (e.g., a user of an eReader of which computer system 400 is a part) to dynamically signal the movement of a visible symbol (cursor) on display 120 and indicate user selections of selectable items displayed on display 120. In some embodiment other implementations of a cursor control device and/or user input device may also be included to provide input to computer system 400, a variety of these are well known and include: trackballs, keypads, directional keys, and the like. System 400 is also well suited to having a cursor directed or user input received by other means such as, for example, voice commands received via microphone 160. System 400 also includes an input/output (I/O) device 420 for coupling system 400 with external entities. For example, in one embodiment, I/O device 420 is a modem for enabling wired communications or modem and radio for enabling wireless communications between system 400 and an external device and/or external network such as, but not limited to, the Internet. I/O device 120 may include a short-range wireless radio such as a Bluetooth® radio, Wi-Fi radio (e.g., a radio compliant with Institute of Electrical and Electronics Engineers' (IEEE) 802.11 standards), or the like.

Referring still to FIG. 4, various other components are depicted for system 400. Specifically, when present, an operating system 422, applications 424, modules 426, and/or data 428 are shown as typically residing in one or some combination of computer usable volatile memory 408 (e.g., RAM), computer usable non-volatile memory 410 (e.g., ROM), and data storage unit 412. In some embodiments, all or portions of various embodiments described herein are stored, for example, as an application 424 and/or module 426 in memory locations within RAM 408, ROM 410, computer-readable storage media within data storage unit 412, peripheral computer-readable storage media 402, and/or other tangible computer readable storage media.

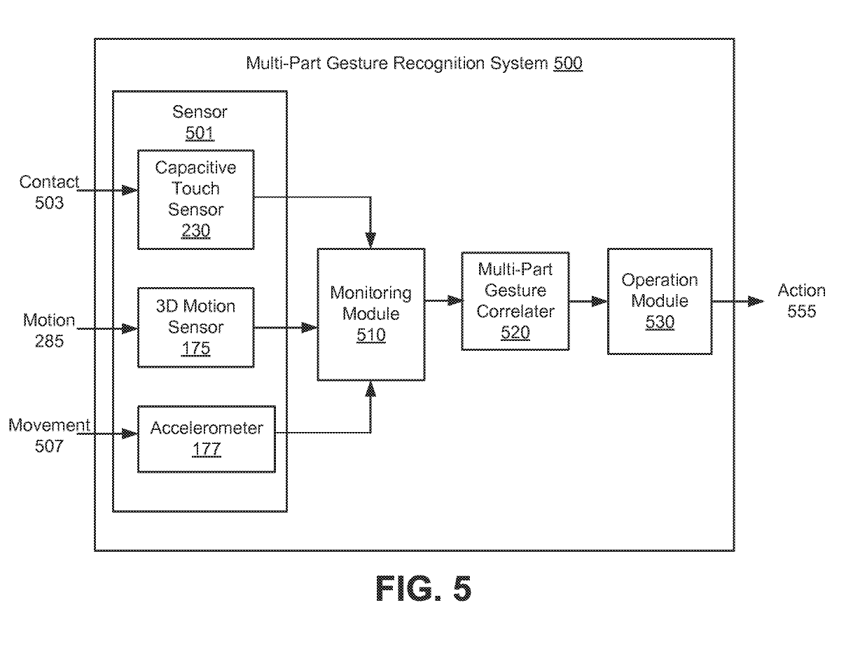

With reference now to FIG. 5, a block diagram of multi-part gesture recognition system 500 for an electronic personal display is shown in accordance with an embodiment. One example of an electronic personal display is an electronic reader (eReader).

In one embodiment, multi-part gesture recognition system 500 includes a monitoring module 510, a multi-part gesture correlater 520 and an operation module 530 that provides an action 555. Although the components are shown as distinct objects in the present discussion, it is appreciated that the operations of one or more of the components may be combined into a single module. Moreover, it is also appreciated that the actions performed by a single module described herein could also be broken up into actions performed by a number of different modules or performed by a different module altogether. The present breakdown of assigned actions and distinct modules are merely provided herein for purposes of clarity.

Sensor 501 is a gesture recognition sensor or group of sensors that may include one or more of: a capacitive touch sensor 230, a 3D motion sensor 175 and an accelerometer 177. In general, capacitive touch sensor 230 senses contact 503, 3D motion sensor 175 recognizes motion 285 in a monitored area; and accelerometer 177 recognizes movement 507 related to the electronic personal display. In one embodiment, capacitive touch sensor 230 may be located on an edge of the housing. In another embodiment, capacitive touch sensor 230 may be located on a rear surface 115 of housing 110. In yet another embodiment, capacitive touch sensor 230 covers the entire housing 110. In general, the capabilities and characteristics of capacitive touch sensor 230 on at least a portion of a housing 110 of the electronic personal display are described in detail herein in the discussion of FIGS. 1-3. As such, for purposes of clarity, instead of repeating the discussion provided in respect to FIGS. 1-3, the discussion of FIGS. 1-3 is incorporated by reference in its entirety herein.

In one embodiment, monitoring module 510 monitors output from sensor 501. For example, when a contact 503, such as by finger 201-1 occurs, a signal is output from the capacitive touch sensor 230 in the area that was touched. In addition to receiving information from capacitive touch sensor 230, monitoring module 510 may also receive motion information from 3D motion sensor 175. For example, when a motion 285, such as by fingers 201 occurs, a signal is output from 3D motion sensor 175 regarding the motion that was performed. Monitoring module 510 may also receive motion information from accelerometer 177. For example, when a movement 507 of the eReader occurs, a signal is output from accelerometer 177 regarding the movement that was observed.

Multi-part gesture correlater 520 receives the multi-part gesture based output from monitoring module 510 divides the multi-part gesture into a first gesture part and at least a second gesture part and correlates each of the parts of the multi-part gesture with an action to be performed by the electronic personal display.

In general, the gesture-action correlation may be factory set, user adjustable, user selectable, or the like. Additionally, the gesture-action performed correlation with the gesture-action for an operation correlation may be adjustable. In one embodiment, if the user's gesture-action is not an exact match to a pre-defined gesture, but is a proximate match for the operation, the correlation settings could be widened such that a gesture with a medium correlation is recognized, or the settings could be narrowed such that only a gesture with a high correlation to the pre-defined gesture will be recognized.

### Example Method of Utilizing a Multi-part Gesture for Operating an Electronic Personal Display

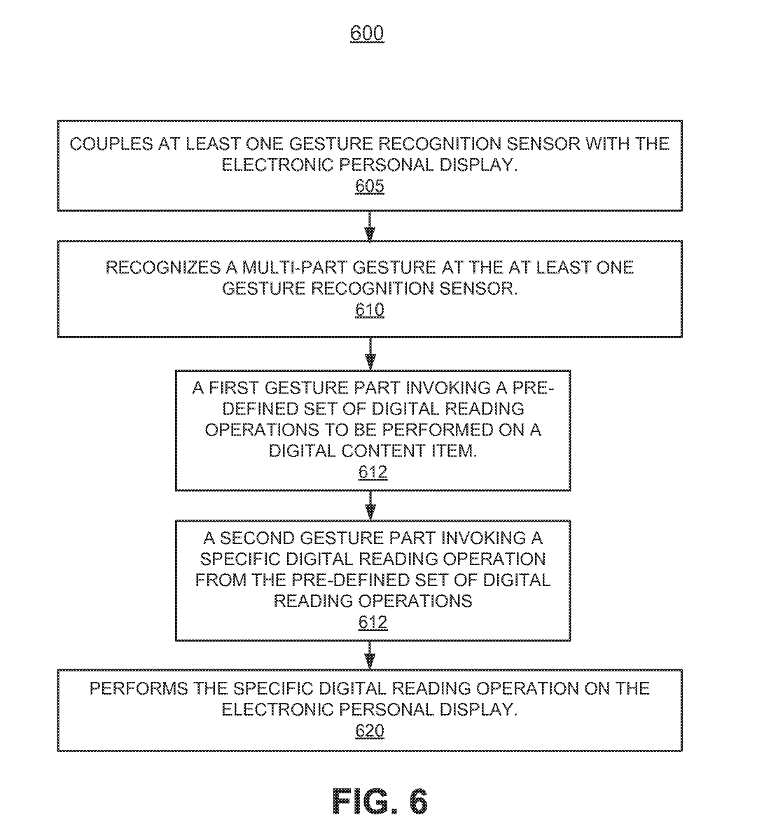

FIG. 6 illustrates a flow diagram 600 of a method for utilizing a multi-part gesture for operating an electronic personal display. In one embodiment, the electronic personal display is an electronic reader (eReader). Elements of flow diagram 600 are described below, with reference to elements of one or more of FIGS. 1-5.

Referring now to 605 of FIG. 6 and to FIGS. 2A-2B and 5, one embodiment couples at least one gesture recognition sensor with the electronic personal display. In general, the at least one gesture recognition sensor may be selected from one or more of a number of gesture recognition sensors, such as but not limited to, a capacitive touch sensing surface, a 3D motion sensor 175 and an accelerometer 177.

For example, in one embodiment, the only gesture recognition sensor coupled with the electronic personal display may be a capacitive touch sensing surface. In another embodiment, the gesture recognition sensors may include a plurality of capacitive touch sensing surfaces. In yet another embodiment, the gesture recognition sensors may include one or more capacitive touch sensing surfaces and the 3D motion sensor 175. In another embodiment, the gesture recognition sensors may include one or more capacitive touch sensing surfaces and the accelerometer 177. In another embodiment, the gesture recognition sensors may include the 3D motion sensor 175 and the accelerometer 177. In another embodiment, the gesture recognition sensors may include one or more capacitive touch sensing surfaces, the 3D motion sensor 175 and the accelerometer 177.

In general, the capacitive touch surface may be, but is not limited to, a grid of conductive lines, a coat of metal, a flexible printed circuit grid and the like. In addition, the capacitive touch sensing surface may utilize directional sensitivity to provide touch-based gesture capabilities.

In one embodiment, the capacitive touch sensing surface may be on only portions of the screen 120, housing 110, sides of housing 110, edges of housing 110, corners of housing 110, rear surface 115 of housing 110, on the entire housing 110, or a combination thereof. For example, the capacitive touch sensing surface may be on one or more of the front surface 111, bottom surface 112, right side surface 113, left side surface 114, rear surface 115, and the top surface (not shown) of housing 110 of eReader 100.

In another embodiment, since housing 110 of the electronic personal display includes one or more capacitive touch sensing surface(s), screen 120 may not necessarily be a capacitive touch sensing surface. Instead, each touch or gesture that would normally be performed on the screen would instead be performed on the housing. In so doing, screen manufacturing costs may be reduced. Additionally, by moving the capacitive touch sensing surface away from the screen, the screen would not be subject to as much touching, swiping, tapping and the like and would provide a cleaner reading surface. However, in another embodiment, the screen of the electronic personal display may have a capacitive touch sensing surface.

In one embodiment, no hard buttons are required for the electronic personal display. That is, there is no need for a hard button on eReader 100 since the capacitive touch sensing surface of the housing 110 is monitored for gestures. In so doing, a greater robustness with regard to dust, fluid contaminants, sand and the like can be achieved. In other words, by removing the hard buttons there are fewer openings through which sand, debris or water can enter the device. Moreover, robustness of the electronic personal display is enhanced since there is no hard button to get gummed up, stuck, spilled on, broken, dropped, dirty, dusty and the like.

3D motion sensor 175 is coupled with the electronic personal display 100 and monitors airspace 275 for a motion associated with the contact. For example, when a contact 503 occurs, a signal is output from the capacitive touch sensor 230 in the area that was touched. In addition 3D motion sensor 175 will provide a signal describing motion information that was performed in the monitored airspace 275 within a predefined time period of the contact 503. The contact 503 and the motion 285 that occurred around the time of contact 503 will then be combined into a single gesture based output.

In one embodiment the predefined time period may be a time window around the time of contact 503. For example, 3D motion sensor 175 may be continuously monitoring airspace 275 for user motions and storing any motions in a looping storage database. When a contact 503 occurs, the monitoring module 510 may refer to the storage database for any motion information that occurred within a predefined time period prior to the contact. For example, monitoring module 510 may refer to a two second time period prior to the contact 503 for any motion information.

In another embodiment, the predefined time period may be a time window that occurs after the time of contact 503. For example, 3D motion sensor 175 may be in a low power state and not monitor airspace 275 for user motions until a contact 503 has occurred. When a contact 503 occurs, the signal would cause 3D motion sensor 175 to begin monitoring the airspace 275 for a certain period of time. For example, 3D motion sensor 175 may commence a two-to-five second time period after contact 503 for any motion information. Although a number of predefined time periods are discussed for purposes of clarification, the actual monitored time period may be greater or less than the stated times.

In one embodiment, 3D motion sensor 175 is fixedly coupled with housing 110 of eReader 100. However, in another embodiment, 3D motion sensor 175 may be removably coupled with eReader 100 such as a wired or wireless connection. Similarly, the accelerometer 177 may be fixedly coupled with the electronic personal display or may be removably coupled with the electronic personal display.

Referring now to 610 of FIG. 6 and to FIGS. 2A-2B and 7A-10B, one embodiment recognizes a multi-part gesture at the at least one gesture recognition sensor. For example, the multi-part gesture may consist of a tapping type contact output received from the capacitive touch sensing surface as the first gesture part; and a swiping type contact output received from the capacitive touch sensing surface as the second gesture part. In another example, the multi-part gesture may consist of a tapping recognition output received from the capacitive touch sensing surface as the first gesture part; and a motion recognition output received from the 3D motion sensor 175 as the second gesture part. Another example includes a shaking recognition output received from the accelerometer 177 as the first gesture part; and a swiping type contact output received from the capacitive touch sensing surface as the second gesture part. In yet another example, a tap recognition output may be received from the accelerometer 177 as the first gesture part; and a motion recognition output received from the 3D motion sensor 175 as the second gesture part.

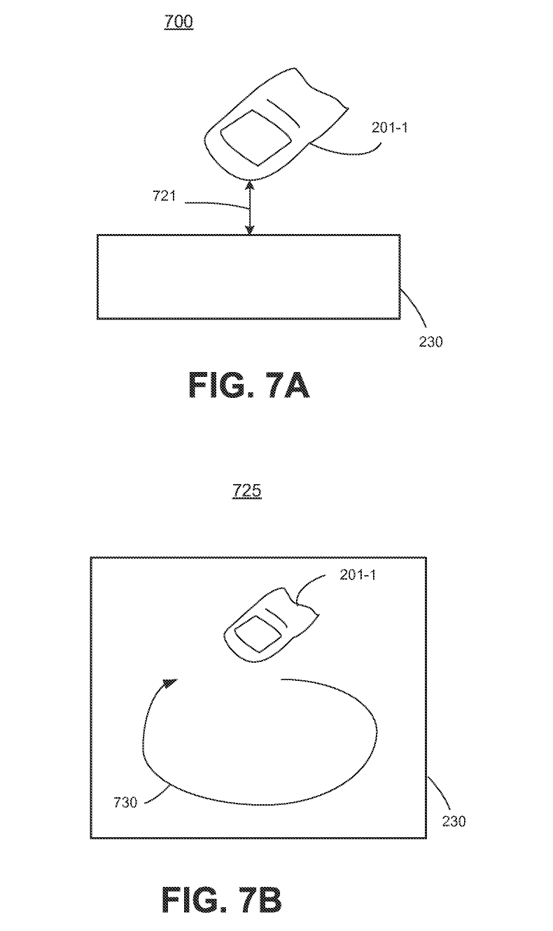

Referring now to 612 of FIG. 6 and to FIGS. 7A-10B, in one embodiment the multi-part gesture consists of a first gesture part invoking a pre-defined set of digital reading operations to be performed on a digital content item rendered on the electronic personal display. In other words, the first part of the multi-part gesture invokes listening for a pre-defined set of menu command options. For example, in one embodiment, tapping on a first pre-determined portion of the capacitive touch sensor 230 may invoke a first drill down set of menu command options drawn toward display settings such as, font type, font size, screen brightness, contrast, magnification and color; while tapping in a second pre-determined portion of the capacitive touch sensing surface would invoke a second drill down set of menu command options drawn toward eBook reading operations such as page turn forward, page turn back, bookmark page, go to last bookmark and the like.

Referring now to 614 of FIG. 6 and to FIGS. 7A-10B, in one embodiment the multi-part gesture consists of a second gesture part invoking a specific digital reading operation from the pre-defined set of digital reading operations. That is, after performing the tapping on a pre-defined portion of the capacitive touch sensor 230 to invoke the functionality described in 612, the multi-part gesturing allows a subsequent action such as swiping down the length of the right hand side/edge of the digital reading device to be interpreted as (i) increasing or decreasing brightness/font size/color contrast/magnification of displayed content.

For example, in FIGS. 7A-7B a multi-part gesture is shown divided into a first gesture part 700 and a second gesture part 725. In FIG. 7A first gesture part 700 is a tapping 721 type contact performed on the touch sensing surface 230. The second gesture part 725 is a circular 730 swiping type contact performed on the touch sensing surface 230. In other words, the multi-part gesture would be a user tapping 721 and then drawing a circle 730 on the touch sensing surface 230. In one embodiment, tapping 721 occurs in the top right quadrant of eReader 100, while the circle 730 may be drawn in the same quadrant or across other quadrants. In this example, tapping in the top right quadrant would signal access to a display change operation menu. In the display change operation menu, circle 730 in a clockwise direction would indicate an increase brightness operation. As such, by performing the above described operation, the display brightness on the eReader would be increased.

In another embodiment, user tapping 721 may occur in the bottom right quadrant of eReader 100, while the circle 730 may be drawn in the same quadrant or across other quadrants. In this example, tapping in the bottom right quadrant would signal access to a reading change operation menu. In the reading change operation menu, circle 730 in a clockwise direction would be a page forward operation. As such, by performing the above described operation, the pages in the book displayed on the eReader would be turned.

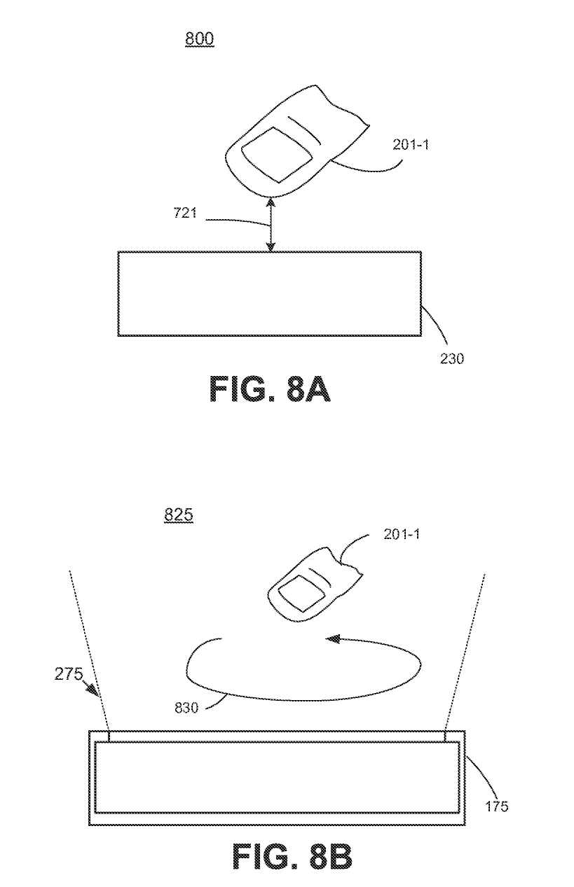

With reference now to FIGS. 8A-8B another embodiment of a multi-part gesture divided into a first gesture part 800 and a second gesture part 825 is shown. First gesture part 800 is a tapping 721 type contact performed on the touch sensing surface 230. The second gesture part 825 is a circular 830 swirl motion performed in range 275 of 3D motion sensor 175. In other words, the multi-part gesture would be a user tapping 721 touch sensing surface 230 and then drawing a circle 830 in the air above 3D motion sensor 175. In one embodiment, tapping 721 occurs in the top right quadrant of eReader 100, while the circle 830 is drawn counterclockwise. In this example, tapping in the top right quadrant would signal access to a display change operation menu. In the display change operation menu, circle 730 in a counterclockwise direction would indicate a decrease brightness operation. As such, by performing the above described operation, the display brightness on the eReader would be decreased.

In another embodiment, user tapping 721 may occur in the bottom right quadrant of eReader 100. In this example, tapping in the bottom right quadrant would signal access to a reading change operation menu. In the reading change operation menu, circle 730 in a counterclockwise direction would be a page back operation. As such, by performing the above described multi-part gesture, the pages in the book displayed on the eReader would be turned back.

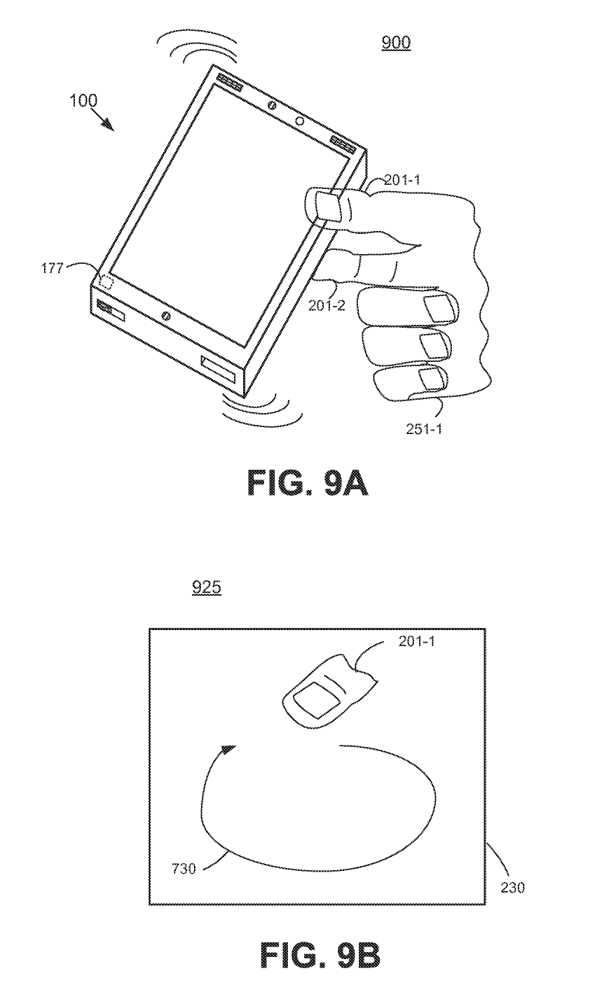

FIGS. 9A-9B illustrate yet another embodiment of a multi-part gesture divided into a first gesture part 900 and a second gesture part 925. First gesture part 900 is a shaking of device 100 recognized by accelerometer 177. The second gesture part 925 is a circular 730 swiping type contact performed on the touch sensing surface 230. In other words, the multi-part gesture would be a user shaking device 100 and then drawing a circle 730 on the touch sensing surface 230. In one embodiment, the shaking occurs in the top to bottom orientation of eReader 100, while the circle 730 may be drawn in the same quadrant or across other quadrants. In this example, shaking would signal access to a main operation menu. In the main operation menu, circle 730 in a clockwise direction would indicate a cycle through available books to read operation. As such, by performing the above described operation, the different books stored on the eReader would be rotationally displayed on the display screen.

In another embodiment, shaking may occur in a left to right fashion of eReader 100, while the circle 730 may be drawn in the same quadrant or across other quadrants. In this example, shaking left to right would signal access to a power change operation menu. In the power change operation menu, circle 730 in a clockwise direction would be a power off operation. As such, by performing the above described operation, the eReader would be turned off.

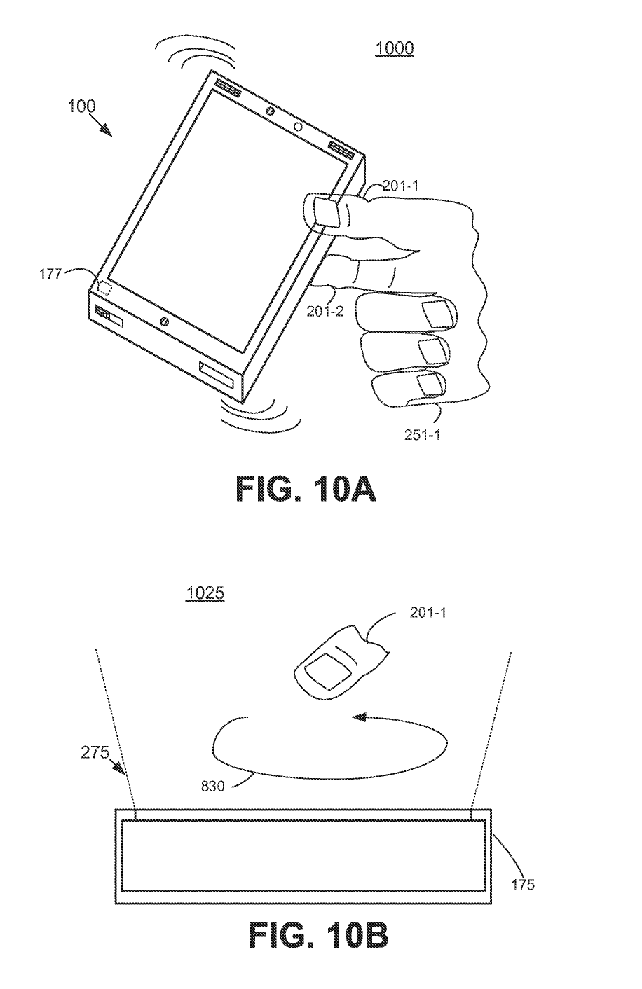

FIGS. 10A-10B illustrate another embodiment of a multi-part gesture divided into a first gesture part 1000 and a second gesture part 1025. First gesture part 1000 is a shaking of device 100 recognized by accelerometer 177. The second gesture part 1025 is a circular 830 swirl motion performed in range 275 of 3D motion sensor 175. In other words, the multi-part gesture would be a user shaking device 100 and then drawing a circle 830 in the air above 3D motion sensor 175. In one embodiment, the shaking occurs in the top to bottom orientation of eReader 100, while the circle 830 is drawn counterclockwise. In this example, shaking would signal access to a main operation menu. In the main operation menu, circle 830 in a counterclockwise direction would indicate a return to the next most recently read book. As such, by performing the above described operation, the next most previous book read on the eReader would be displayed.

In another embodiment, shaking may occur in a left to right fashion of eReader 100. In this example, shaking left to right would signal access to a power change operation menu. In the power change operation menu, circle 830 in a counter clockwise direction would be a power on operation. As such, by performing the above described operation, the eReader would be turned on. Although a number of gestures and operations have been described as being correlated herein, it should be understood that the gesture-operation correlations may be different or may be user adjustable.

Referring now to 615 of FIG. 6 and to FIGS. 2A-2B and 5, one embodiment initiates the specific digital reading operation on the electronic personal display. In general, the types of contact 503 and motions 285 that may be correlated to become a predefined gesture may be wide ranging and could be additionally expanded by a user's individual preferences. Moreover, the user may expand the predefined gestures by developing and storing individualized gestures. For example, one user may define a bookmarking operation as a contact followed by a checkmark type of motion while another user may define a bookmarking operation as a contact followed by an “ok” motion.

In one embodiment, if a gesture with no associated action is performed a number of times within a certain time period, a help menu may pop up in an attempt to ascertain the user's intention. In one embodiment, the menu may provide insight to allow the user to find the proper multi-part gesture for the desired action. In another embodiment, the menu may include an “ignore this gesture” option. For example, if a user were a habitual tapper, after repeated tapping the help menu may pop-up to provide assistance. The user could simply select the “ignore this gesture” option and the gesture would then be ignored or the habitual tapping gesture may be assigned as “take no additional action”.

The foregoing Description of Embodiments is not intended to be exhaustive or to limit the embodiments to the precise form described. Instead, example embodiments in this Description of Embodiments have been presented in order to enable persons of skill in the art to make and use embodiments of the described subject matter. Moreover, various embodiments have been described in various combinations. However, any two or more embodiments may be combined. Although some embodiments have been described in a language specific to structural features and/or methodological acts, it is to be understood that the subject matter defined in the appended claims is not necessarily limited to the specific features or acts described above. Rather, the specific features and acts described above are disclosed by way of illustration and as example forms of implementing the claims and their equivalents.

What is claimed is:

1. A method for utilizing a multi-part gesture for operating an electronic personal display, said method comprising:
coupling at least one gesture recognitions sensor with the electronic personal display;
recognizing a multi-part gesture at the at least one gesture recognition sensor, wherein the multi-part gesture comprises:
a first gesture part invoking a pre-defined set of digital reading operations to be performed on a digital content item rendered on the electronic personal display;
at least a second gesture part invoking a specific digital reading operation from the pre-defined set of digital reading operations; and
performs the specific digital reading operation on the electronic personal display.

2. The method of claim 1 further comprising:
utilizing a capacitive touch sensing surface for at least one gesture recognition sensor for recognizing one or more parts of the multi-part gesture.

3. The method of claim 2 further comprising:
receiving a tapping type contact output from the capacitive touch sensing surface as the first gesture part; and
receiving a swiping type contact output from the capacitive touch sensing surface as the second gesture part.

4. The method of claim 2 further comprising:
providing the capacitive touch sensing surface on a housing of the electronic personal display.

5. The method of claim 2 further comprising:
utilizing a 3D motion sensor for at least a second gesture recognition sensor for recognizing one or more parts of the multi-part gesture.

6. The method of claim 5 further comprising:
receiving a tapping recognition output from the capacitive touch sensing surface as the first gesture part; and
receiving a motion recognition output from the 3D motion sensor as the second gesture part.

7. The method of claim 5 further comprising:
fixedly coupling the 3D motion sensor with the electronic personal display.

8. The method of claim 2 further comprising:
utilizing an accelerometer for at least a second gesture recognition sensor for recognizing one or more parts of the multi-part gesture.

9. The method of claim 8 further comprising:
receiving a shaking recognition output from the accelerometer as the first gesture part; and
receiving a swiping type contact output from the capacitive touch sensing surface as the second gesture part.

10. The method of claim 1 further comprising:
utilizing a 3D motion sensor as at least a first gesture recognition sensor for recognizing one or more parts of the multi-part gesture; and
utilizing an accelerometer as at least a second gesture recognition sensor for recognizing one or more parts of the multi-part gesture.

11. The method of claim 10 further comprising:
receiving a tap recognition output from the accelerometer as the first gesture part; and
receiving a motion recognition output from the 3D motion sensor as the second gesture part.

12. An electronic reader (eReader) with multi-part gesture recognition comprising:
at least one gesture recognition sensor coupled with the eReader;
a monitoring module to monitor the gesture recognition sensor for a multi-part gesture related to a digital reading operation and provide an output when the multi-part gesture is detected, the multi-part gesture comprising:
a first gesture part to delineate a pre-defined set of menu command options; and
at least a second gesture part to select a specific command from the pre-defined set of menu command options; and
a gesture correlater to correlate the first gesture part received from the monitoring module with the pre-defined set of menu command options and to correlate the second gesture part received from the monitoring module with the specific command from the pre-defined set of menu command options; and
an operation module to receive the output from the monitoring module and perform the digital reading operation on a digital content item rendered on the eReader.

13. The eReader of claim 12 wherein the at least one gesture recognition sensor is a capacitive touch sensing surface.

14. The eReader of claim 13 wherein the capacitive touch sensing surface is located on a housing of the eReader.

15. The eReader of claim 12 wherein the at least one gesture recognition sensor is a 3D motion sensor.

16. The eReader of claim 15 wherein the 3D motion sensor is fixedly coupled with the eReader.

17. The eReader of claim 12 wherein the at least one gesture recognition sensor is an accelerometer.

18. A method for utilizing a multi-part gesture for operating an electronic reader (eReader), said method comprising:
receiving a first gesture part of a multi-part gesture from at least one gesture recognition sensor coupled with the eReader;
correlating the first gesture part with a predefined gesture invoking a pre-defined set of menu command options;
receiving a second gesture part of the multi-part gesture from the at least one gesture recognition sensor coupled with the eReader;
correlating the second gesture part of the multi-part gesture with a predefined gesture denoting a digital reading operation to be performed on a digital content item rendered on the eReader; and
performing the digital reading operation on the eReader.

19. The method of claim 18 further comprising:
utilizing a capacitive touch sensing surface for recognizing one or more parts of the multi-part gesture.

20. The method of claim 18 further comprising:
utilizing a 3D motion sensor in conjunction with a capacitive touch sensing surface for recognizing one or more parts of the multi-part gesture.

21. The method of claim 18 further comprising:
utilizing an accelerometer in conjunction with a capacitive touch sensing surface for recognizing one or more parts of the multi-part gesture.
